(19) United States
(12) Patent Application Publication
(10) Pub. No.: US 2009/0237332 A1
(43) Pub. Date: Sep. 24, 2009

(54) PIXEL AND ORGANIC LIGHT EMITTING DISPLAY DEVICE USING THE SAME

(76) Inventor: Deok-Young Choi, Suwon-si (KR)

Correspondence Address: CHRISTIE, PARKER & HALE, LLP, PO BOX 7068, PASADENA, CA, 91109-7068, US

(21) Appl. No.: 12/365,430

(22) Filed: Feb. 4, 2009

(30) Foreign Application Priority Data
Mar. 24, 2008 (KR) 10-2008-0026794

(51) Int. Cl. G09G 3/30

(52) U.S. Cl. 345/76

(57) ABSTRACT

A pixel for use in a light emitting display capable of being stably initialized without a separate initialization power. An exemplary embodiment of the pixel includes six transistors, a storage capacitor, and an organic light emitting diode OLED. A data signal supplied through a data line is transmitted into the pixel in response to a current scan signal supplied through a current scan line. A drive current corresponding to the data signal drives the OLED. One transistor is utilized to diode-connect the driving transistor in response to the current scan signal, compensating for variability in the threshold voltage of the driving transistor. The storage capacitor stores the data signal. The storage capacitor is initialized to a low voltage in response to a previous scan signal supplied before the current scan signal. The organic light emitting diode OLED emits light corresponding to the drive current supplied from the driving transistor.

### CROSS-REFERENCE TO RELATED APPLICATIONS

This application claims priority to and the benefit of Korean Patent Application No. 10-2008-0026794, filed on Mar. 24, 2008, in the Korean Intellectual Property Office, the entire content of which is incorporated herein by reference.

### BACKGROUND OF THE INVENTION

1. Field of the Invention

The present invention relates to a pixel and an organic light emitting display device using the same.

2. Description of Related Art

Recently, various flat panel display devices having reduced weight and volume compared to cathode ray tubes (CRT) have been developed. Among flat panel display devices, an organic light emitting display device displays images using organic light emitting diodes OLEDs, which are self light emitting devices. An organic light emitting display has advantages of excellent brightness and color purity so that it is being spotlighted as a next generation display device.

The organic light emitting display device may be a passive matrix organic light emitting display device or an active matrix organic light emitting display device, depending on the driving method of the organic light emitting diodes.

An active matrix organic light emitting display device includes a plurality of pixels positioned at crossing areas of scan lines and data lines. Further, each of the pixels in the active matrix device includes an organic light emitting diode and a pixel circuit to drive it. The pixel circuit conventionally includes a switching transistor, a driving transistor, and a storage capacitor.

The active matrix organic light emitting display device generally has a low power consumption, and accordingly it is useful for portable display devices.

However, an issue with a conventional active matrix organic light emitting display device is multiform defects in images due to the difference in brightness between the pixels caused by threshold voltage variations in driving transistors.

Accordingly, pixel circuits having various structures have been suggested to attempt to compensate for the threshold voltage variations of the driving transistor. For example, a pixel structure having a compensation transistor to diode-connect the driving transistor during a predetermined period has been widely known.

However, when compensating for the threshold voltage variations by diode-connecting the driving transistor, a data signal may not be properly utilized due to a changing voltage level of the data signal in sequential frames.

For example, in the case where the voltage level of the data signal in a current frame is lower than that of the data signal in a previous frame, the driving transistor is diode-connected in a reverse direction, and thus a problem may arise in that the data signal is not normally entered into the pixel.

Accordingly, to address this issue, it is desired to efficiently initialize each pixel before entering the data signal.

However, for this initialization, in the case where a separate initialization power is coupled to each pixel, the number of signal lines within the display region may be increased. Accordingly, a restriction in pixel layout occurs, and thus a difficulty may arise in embodying a panel having a high resolution.

### SUMMARY

Therefore, various embodiments of the present invention provide a pixel and an organic light emitting display device using the same, which is capable of stably initializing a pixel without a separate initialization power supply.

A first exemplary embodiment of the present invention provides a pixel including first, second, third, and fourth transistors, a storage capacitor, and an organic light emitting diode (OLED). The first transistor transmits a data signal supplied through a data line in response to a current scan signal supplied through a current scan line. The second transistor generates a drive current in response to the data signal transmitted through the first transistor. The third transistor diode-connects the second transistor in response to the current scan signal. The storage capacitor stores a voltage corresponding to the data signal transmitted to the second transistor. The fourth transistor initializes the storage capacitor in response to a previous scan signal supplied through a previous scan line before the current scan signal is supplied through the current scan line. To this end, the fourth transistor is coupled between a light emitting control line and the storage capacitor, so it can initialize the storage capacitor with a voltage level of a light emitting control signal supplied through the light emitting control line when the previous scan signal is supplied. The organic light emitting diode OLED emits light in response to the drive current supplied from the second transistor.

Here, the storage capacitor may be initialized by a low level light emitting control voltage of the light emitting control signal when the previous scan signal is supplied.

The light emitting control signal may be maintained while the previous scan signal and the current scan signal are supplied through the previous scan line and the current scan line, respectively.

Here, the previous scan signal and the current scan signal may be sequentially supplied with a low level previous scan voltage and a low level current scan voltage, respectively, and the light emitting control signal may have a low level light emitting control voltage when the previous scan signal and the current scan signal are supplied, and may rise to a high level light emitting control voltage after the current scan signal rises to a high level current scan voltage.

Further, the pixel may include a fifth transistor for coupling the second transistor to a first power source ELVDD in response to the light emitting control signal supplied through the light emitting control line, wherein the fifth transistor comprises a conductivity type different from that of the first to fourth transistors. That is, the first to fourth transistors may be P-type transistors and the fifth transistor may be an N-type transistor.

The pixel may further include a sixth transistor for coupling the second transistor to the organic light emitting diode in correspondence the light emitting control signal supplied through the light emitting control line, wherein the sixth transistor comprises a conductivity type different from that of the first to fourth transistors. That is, the first to the fourth transistors may comprise P-type transistors and the sixth transistor may comprise an N-type transistor.

A second exemplary embodiment of the present invention is an organic light emitting display device including a plurality of scan lines for supplying a scan signals, a plurality of light emitting control lines for supplying a light emitting control signal, a plurality of data lines for supplying a data signal, and a plurality of pixels at crossing areas of the scan lines, the light emitting control lines, and the data lines. A first transistor is for transmitting the data signal supplied through a data line of the plurality of data lines in response to the current scan signal supplied through a current scan line of the plurality of scan lines. A second transistor is for generating a drive current corresponding to the data signal transmitted through the first transistor. A third transistor is for diode-connecting the second transistor in response to the current scan signal. A storage capacitor is for storing the data signal transmitted to the second transistor. A fourth transistor is for initializing the storage capacitor in response to the previous scan signal supplied before the current scan signal is supplied. An organic light emitting diode OLED is for emitting light corresponding to the drive current supplied from the second transistor. The fourth transistor is coupled between a light emitting control line of the plurality of light emitting control lines and the storage capacitor, thereby initializing the storage capacitor with a voltage level of a light emitting control signal supplied through the light emitting control line in response to the previous scan signal. Furthermore, the light emitting control line controls an electrical isolation between the second transistor and the organic light emitting diode OLED.

The pixel may be initialized by a low level light emitting control voltage of the light emitting control signal in response to the previous scan signal.

Further, each pixel of the plurality of pixels may include a fifth transistor for coupling the second transistor to a first power supply ELVDD in response to the light emitting control signal supplied through the light emitting control line, wherein the fifth transistor is of a conductivity type different from that of the first to fourth transistors. For example, the first to fourth transistors may be P-type transistors and the fifth transistor may be an N-type transistor.

Further, each pixel of the plurality of pixels may include a sixth transistor for coupling the second transistor to the organic light emitting diode OLED in response to the light emitting control signal supplied through the light emitting control line, wherein the sixth transistor is of a conductivity type different from that of the first to fourth transistors. That is, the first to the fourth transistors may be P-type transistors and the sixth transistor may be an N-type transistor.

As described above, various embodiments of the present invention may be utilized to stably initialize the pixel using a low level voltage of the light emitting control signal without need for a separate initialization power.

Accordingly, the pixel according to an exemplary embodiment of the present invention is efficiently driven by a relatively small number of signal lines, thereby reducing a restriction according to a layout of the pixels. Therefore, a pixel and the organic light emitting display device using the same is provided, which may be usefully applied to a panel having a high resolution.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram illustrating an organic light emitting display device according to an exemplary embodiment of the present invention;

FIG. 2 is a schematic circuit diagram illustrating a pixel according to an embodiment of the present invention;

FIG. 3 is a timing diagram of drive signals to drive the pixel illustrated in FIG. 2; and

FIG. 4A-FIG. 4C are schematic circuit diagrams for explaining an operation of the pixel illustrated in FIG. 2 according to the timing diagram illustrated in FIG. 3.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be directly coupled to the second element, or it but may be indirectly coupled to the second element via a third element. Further, some of the elements that are not essential to a complete understanding of the invention have been omitted for clarity. Also, like reference numerals refer to like elements throughout.

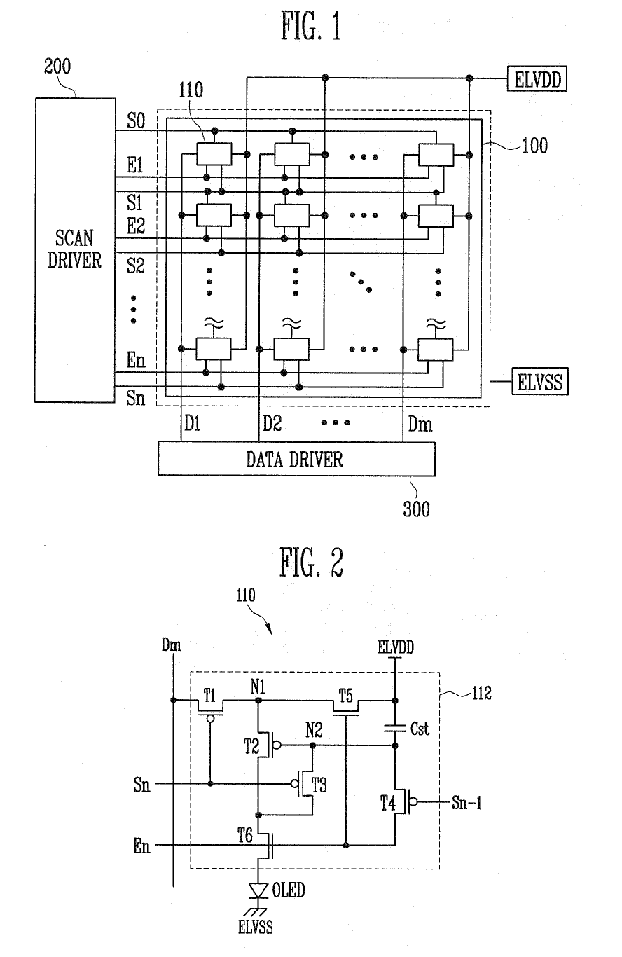

FIG. 1 is a block diagram illustrating an organic light emitting display device according to an exemplary embodiment of the present invention.

Referring to FIG. 1, an organic light emitting display device according to an exemplary embodiment of the present invention includes a display region 100, a scan driver 200, and a data driver 300.

The display region 100 includes a plurality of pixels 110 arranged similarly to a matrix at crossing areas of scan lines S1 to Sn, light emitting control lines E1 to En, and data lines D1 to Dm.

A row of the pixels 110 is coupled to a scan line (hereinafter referred to as “a current scan line” with respect to this row of pixels 110); a light emitting control line; and a scan line of a previous row (hereinafter referred to as “a previous scan line” with respect to this row of pixels 110). A column of the pixels 110 is coupled to a data line. For example, the pixel 110 located at an i-th line and a j-th column is coupled to an i-th scan line Si, an i-th light emitting control line Ei, an i-1-th scan line Si-1 (i.e., the previous scan line) and a j-th data line Dj.

Each pixel 110 is initialized with a voltage of a light emitting control signal when a previous scan signal is supplied through the previous scan line Si-1. Each pixel 110 receives a data signal supplied through the data line Dm when the scan signal is supplied through the current scan line Sn. The pixels 110 display at least a portion of images by emitting light with a brightness corresponding to the voltage of the data signal.

The display region 100 receives a first power supply ELVDD and a second power supply ELVSS supplied from the outside (i.e., a power supply). The first power supply ELVDD and the second power supply ELVSS are supplied to the pixels 110 and are used as a driving power of the pixels 110.

The scan driver 200 generates the scan signals in response to a scan control signal supplied from the outside (i.e., a timing controller). The scan signal generated at the scan driver 200 is sequentially supplied to the pixels 110 through the scan lines S1 to Sn.

The data driver 300 generates the data signals in response to data supplied from the outside (i.e., the timing controller). The data signals generated by the data driver 300 are supplied to the pixels 110 through the data lines D1 to Dm so as to be synchronized with the scan signal.

As described above, the organic light emitting display device according to an exemplary embodiment of the present invention may stably initialize the pixel using the light emitting control signal without a separate initialization power. Hereinafter, a more detailed description will be provided.

FIG. 2 is a circuit diagram illustrating a pixel 110 according to an exemplary embodiment of the present invention. The pixel 110 illustrated in FIG. 2 may be applied to an embodiment of the organic light emitting display device illustrated in FIG. 1. For convenience of description, FIG. 2 illustrates a pixel located at the n-th line and the m-th column.

Referring to FIG. 2, the pixel 110 according to an exemplary embodiment of the present invention includes a pixel circuit 112 and an organic light emitting diode OLED driven by the pixel circuit 112.

The pixel circuit 112 includes first to sixth transistors T1 to T6 and a storage capacitor Cst. Here, the first to fourth transistors T1 to T4 may be of the same conductivity type as each other, for example, as illustrated in FIG. 2, P-type transistors. The fifth and sixth transistors T5 and T6 may be of a conductivity type different from the first to fourth transistors T1 to T4, for example, as illustrated in FIG. 2, N-type transistors.

The first transistor T1 transmits the data signal supplied through the data line Dm within the pixel 110 in response to the current scan signal supplied through the current scan line Sn. For this purpose, the first transistor T1 is coupled between the data line Dm and a first node N1, and a gate electrode of the first transistor T1 is coupled to the current scan line Sn.

The second transistor T2 generates a drive current during a luminescence period of the pixel 110 in correspondence to the data signal transmitted through the first transistor T1, and supplies it to the organic light emitting diode OLED. For this purpose, the second transistor T2 is coupled between the first node N1 and the organic light emitting diode OLED. Further, a gate electrode of the second transistor T2 is coupled to a second node N2 to be coupled to the storage capacitor Cst, which stores the data signal.

The third transistor T3 is for diode-connecting the second transistor T2 in response to the current scan signal supplied to the current scan line Sn. For this purpose, the third transistor T3 is coupled between the gate electrode and the drain electrode of the second transistor T2, and the gate electrode of the third transistor T3 is coupled to the current scan line Sn.

The fourth transistor T4 may be used to initialize a storage capacitor Cst in response to the previous scan signal supplied through the previous scan line Sn-1 before the current scan signal is supplied through the current scan line Sn. For this purpose, the fourth transistor T4 is coupled between the storage capacitor Cst and the light emitting control line En, and the gate electrode of the fourth transistor T4 is coupled to the previous scan line Sn-1. Namely, the fourth transistor T4 is turned on when the previous scan signal is supplied through the previous scan line Sn-1, thereby initializing the storage capacitor Cst with a voltage level of the light emitting control signal supplied through the light emitting control line En.In one embodiment, the light emitting control signal has a low level when the previous scan signal is supplied to the previous scan line Sn-1.

The fifth transistor T5 couples the second transistor T2 to the first power supply ELVDD in response to the light emitting control signal supplied through the light emitting control line En. Thus, the fifth transistor T5 is coupled between the first node N1 and the first power supply ELVDD, selectively coupling the first power supply ELVDD to the second transistor T2. Further, the gate electrode of the fifth transistor T5 is coupled to the light emitting control line En. Thus, the fifth transistor T5 couples the second transistor T2 to the first power supply ELVDD during the luminescence period of the pixel. During the remaining time, namely, when the pixel 110 is initialized and the data signal is stored in the storage capacitor Cst, the fifth transistor T5 decouples the second transistor T2 from the first power supply ELVDD. The light emitting control signal has a low level during the supply period of the previous scan signal. Therefore, to maintain an off state during this period, unlike the first to the fourth transistors T1 to T4, in this embodiment, the fifth transistor T5 is an N-type transistor.

The sixth transistor T6 couples the second transistor T2 to the organic light emitting diode OLED in response to the light emitting control signal supplied from the light emitting control line En. Accordingly, the drive current supplied from the second transistor T2 is supplied to the organic light emitting diode OLED through the sixth transistor T6. So as to do this, the sixth transistor T6 is coupled between the second transistor T2 and the organic light emitting diode OLED, and the gate electrode of the sixth transistor T6 is coupled to the light emitting control line En. To stably drive the pixel 110, the sixth transistor T6 electrically isolates the second transistor T2 from the organic light emitting diode OLED during the period when the pixels are initialized and the data signal is stored in the storage capacitor Cst. The sixth transistor T6 couples the second transistor to the organic light emitting diode OLED during a succeeding luminescence period. Accordingly, in this embodiment the sixth transistor T6 is an N-type transistor like the fifth transistor T5.

The storage capacitor Cst is initialized by the voltage level of the light emitting control signal supplied through the fourth transistor T4 when the previous scan signal is supplied to the previous scan line Sn-1. The storage capacitor Cst stores the data signal supplied via the first to third transistors T1 to T3 during the supply period of the scan signal to the current scan line Sn. However, during the supply period of the data signal, the second transistor T2 is diode-connected by the third transistor T3, and thus a voltage corresponding to the difference between the voltage of the data signal and the threshold voltage of the second transistor T2 is stored in the storage capacitor Cst.

The organic light emitting diode OLED is coupled between the pixel circuit 112 and a second power supply ELVSS. Such an organic light emitting diode OLED emits light corresponding to the driving current supplied by the first power supply ELVDD, through the fifth transistor T5, the second transistor T2 and the sixth transistor T6 during the luminescence period.

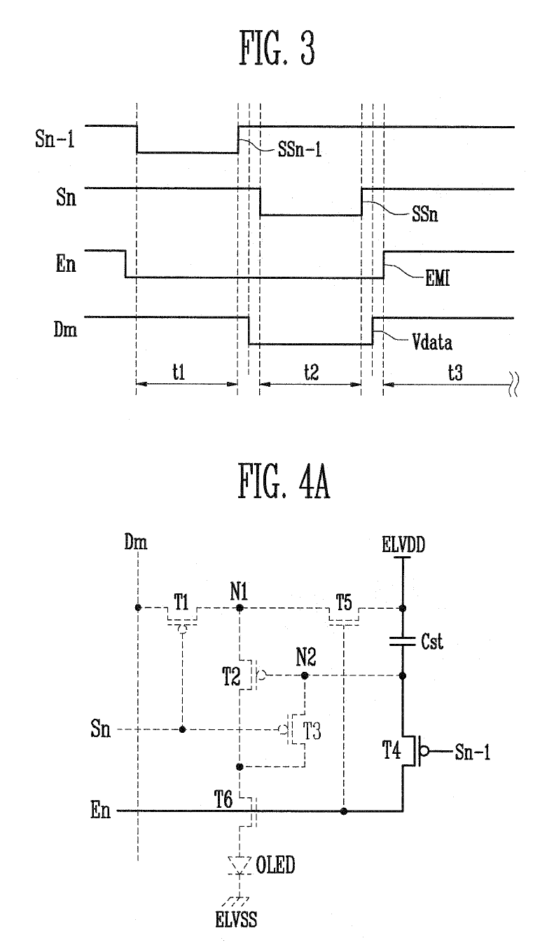

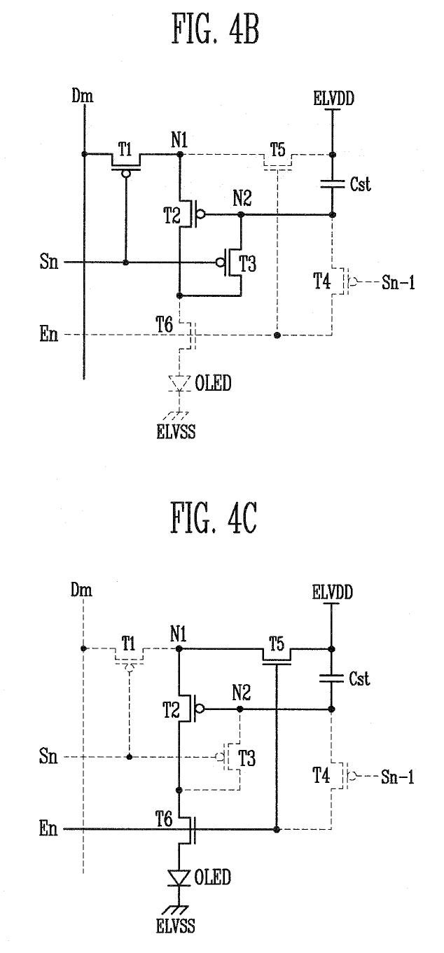

Hereinafter, the operation of the pixel 110 will be explained in detail with reference to FIG. 3 to FIG. 4C.

Referring to FIG. 3 to 4C, the previous scan signal SSn-1 and the light emitting control signal EMI of a low level are supplied during a period t1, and the current scan signal SSn and a data signal Vdata maintain a high level.

As shown in FIG. 4A, the fourth transistor T4 is turned on in response to the previous scan signal SSn-1 of a low level. By this, the light emitting control signal EMI of a low level is transmitted to the storage capacitor Cst and the storage capacitor Cst is initialized by the low level voltage value of the light emitting control signal EMI. Namely, the pixel 110 is initialized by the low level voltage value of the light emitting control signal EMI during the period t1. The low level voltage value of the light emitting control signal EMI is set as a value capable of initializing the pixel 110. For example, the low level voltage value of the light emitting control signal EMI may be set to be less than the minimum voltage value of the data signal Vdata.

Thereafter, at the end of the period t1, the previous scan signal SSn-1 rises to a high level, thereafter maintaining the high level. The current scan signal SSn and data signal Vdata of a low level are supplied during a succeeding period t2. The light emitting control signal EMI maintains the low level throughout the period t1 and the period t2. As a result, as shown in FIG. 4B, the first and third transistors T1 and T3 are turned on in response to the current scan signal SSn of a low level, and the second transistor T2 to be diode-connected by the third transistor T3 is turned on. Accordingly, the data signal Vdata supplied to the data line Dm is supplied to the second node N2 via the first to third transistors T1-T3. More specifically, because the second transistor T2 is diode-connected, a voltage corresponding to a difference between the voltage of the data signal Vdata and the threshold voltage of the second transistor T2 is supplied to the second node N2. The voltage supplied to the second node N2 is stored in the storage capacitor Cst, and is maintained during one frame.

Thereafter, during a succeeding period t3, the light emitting control signal EMI rises to a high level, thereafter maintaining the high level. The previous scan signal SSn-1, the current scan signal SSn and the data signal Vdata also maintain the high level. Thus, as illustrated in FIG. 4C, the fifth and sixth transistors T5 and T6 are turned on by the light emitting control signal EMI at the high level. Accordingly, a drive current flowing into the second power supply ELVSS from the first power supply ELVDD through the fifth transistor T5, the second transistor T2, the sixth transistor T6 and the organic light emitting diode OLED, is generated. At this time, the drive current is controlled by the second transistor T2, which generates a voltage supplied to a gate electrode thereof, namely, the drive current corresponding to a voltage stored in the storage capacitor Cst. On the other hand, during the period t2, a voltage is stored in the storage capacitor Cst, in which the threshold voltage of the second transistor T2 is reflected, and thus the pixel circuit can compensate for variations in the threshold voltage of the second transistor T2. Accordingly, an essentially uniform drive current corresponding to the data signal Vdata, with little to no relation to the threshold voltage of the second transistor T2, flows during the period t3.

As described above, the exemplary embodiment of the present invention is capable of stably initializing the pixel 110 using the low level voltage of the light emitting control signal EMI during the period t1 without a separate initialization power.

Accordingly, the pixel 110 is efficiently driven with a relatively small number of signal lines, thereby reducing a restriction according to a layout of the pixel 110. Therefore, it is provided with the pixel and the organic light emitting display device, which may be usefully applied to a display panel of high resolution.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel comprising:
a first transistor for transmitting a data signal supplied through a data line in response to a current scan signal supplied through a current scan line;
a second transistor for generating a drive current corresponding to the data signal transmitted through the first transistor;
a third transistor for diode-connecting the second transistor in response to the current scan signal;
a storage capacitor for storing a voltage corresponding to the data signal transmitted through the second transistor;
a fourth transistor for initializing the storage capacitor in response to a previous scan signal supplied through a previous scan line before the current scan signal is supplied through the current scan line;
an organic light emitting diode for emitting light in response to the drive current supplied from the second transistor; and
a light emitting control line for controlling an electrical isolation between the second transistor and the organic light emitting diode,
wherein the fourth transistor is coupled between the light emitting control line and the storage capacitor for initializing the storage capacitor with a voltage level of a light emitting control signal supplied through the light emitting control line when the previous scan signal is supplied.

2. The pixel of claim 1, wherein the storage capacitor is configured to be initialized by a low level light emitting control voltage of the light emitting control signal when the previous scan signal is supplied.

3. The pixel of claim 1, wherein the light emitting control signal is adapted to be maintained while the previous scan signal and the current scan signal are supplied through the previous scan line and the current scan line, respectively.

4. The pixel of claim 1, wherein the previous scan signal and the current scan signal are sequentially supplied with a low level previous scan voltage and a low level current scan voltage, respectively, and
wherein the light emitting control signal has a low level light emitting control voltage when the previous scan signal and the current scan signal are supplied, and rises to a high level light emitting control voltage after the current scan signal rises to a high level current scan voltage.

5. The pixel of claim 1, further comprising:
a fifth transistor for coupling the second transistor to a first power source in response to the light emitting control signal supplied through the light emitting control line, wherein the fifth transistor comprises a conductivity type different from that of the first to fourth transistors.

6. The pixel of claim 5, wherein the first to fourth transistors comprise P-type transistors and the fifth transistor comprises an N-type transistor.

7. The pixel of claim 1, further comprising:
a sixth transistor for coupling the second transistor to the organic light emitting diode in response to the light emitting control signal supplied through the light emitting control line, wherein the sixth transistor is of a conductivity type different from that of the first to fourth transistors.

8. The pixel of claim 7, wherein the first to fourth transistors comprise P-type transistors and the sixth transistor comprises an N-type transistor.

9. An organic light emitting display comprising:
a plurality of scan lines for supplying scan signals comprising a current scan signal and a previous scan signal;
a plurality of light emitting control lines for supplying a light emitting control signal;
a plurality of data lines for supplying a data signal; and
a plurality of pixels at crossing areas of the scan lines, the light emitting control lines and the data lines,
wherein each pixel of the plurality of pixels comprises:
a first transistor for transmitting the data signal supplied through a data line of the plurality of data lines in response to the current scan signal supplied through a current scan line of the plurality of current scan lines;
a second transistor for generating a drive current corresponding to the data signal transmitted through the first transistor;
a third transistor for diode-connecting the second transistor in response to the current scan signal;
a storage capacitor for storing the data signal transmitted to the second transistor;
a fourth transistor for initializing the storage capacitor in response to the previous scan signal supplied before the current scan signal is supplied; and
an organic light emitting diode for emitting light corresponding to the drive current supplied from the second transistor,
wherein the fourth transistor is coupled between a light emitting control line of the plurality of light emitting control lines and the storage capacitor, for initializing the storage capacitor with a voltage level of a light emitting control signal supplied through the light emitting control line in response to the previous scan signal, and
wherein the light emitting control line is further configured to control an electrical isolation between the second transistor and the organic light emitting diode.

10. The organic light emitting display device of claim 9, wherein the pixel is configured to be initialized by a low level light emitting control voltage of the light emitting control signal in response to the previous scan signal.

11. The organic light emitting display device of claim 9, wherein each pixel of the plurality of pixels further comprises: a fifth transistor for coupling the second transistor to a first power supply in response to the light emitting control signal supplied through the light emitting control line, wherein the fifth transistor is of a conductivity type different from that of the first to fourth transistors.

12. The organic light emitting display device of claim 11, wherein the first to fourth transistors comprise P-type transistors and the fifth transistor comprises an N-type transistor.

13. The organic light emitting display device of claim 9, wherein each pixel of the plurality of pixels further comprises a sixth transistor for coupling the second transistor to the organic light emitting diode in response to the light emitting control signal supplied through the light emitting control line, wherein the sixth transistor is of a conductivity type different from that of the first to fourth transistors.

14. The organic light emitting display device of claim 13, wherein the first to fourth transistors comprise P-type transistors and the sixth transistor comprises an N-type transistor.

15. A method of driving an organic light emitting display comprising a plurality of scan lines, a plurality of light emitting control lines, and a plurality of data lines crossing the scan lines and the light emitting control lines, and a plurality of pixels at crossing regions of the scan lines, the light emitting control lines, and the data lines, wherein a pixel among the plurality of pixels comprises a driving transistor, a storage capacitor, and an organic light emitting diode, and the pixel is coupled to a current scan line and a previous scan line from among the scan lines, a data line from among the data lines, and a light emitting control line among the light emitting control lines, the method comprising:
electrically isolating the organic light emitting diode from the driving transistor in response to a light emitting control signal of a first voltage level on the light emitting control line;
initializing the storage capacitor with an initialization voltage of the light emitting control signal when a previous scan signal is transmitted through the previous scan line;
diode-connecting the driving transistor when a current scan signal is transmitted through the current scan line;
charging the storage capacitor with a driving voltage corresponding to a data signal on the data line and a threshold voltage of the driving transistor when the current scan signal is transmitted through the current scan line; and
utilizing the driving transistor to drive a current from a first power supply through the driving transistor and through the organic light emitting diode to a second power supply in response to the light emitting control signal of a second voltage level.

16. The method of claim 15, wherein the initialization voltage of the light emitting control signal comprises a low level voltage relative to a first power supply voltage of the first power supply.

17. The method of claim 15, further comprising maintaining a substantially constant voltage on the light emitting control line while the previous scan signal and the current scan signal are supplied through the previous scan line and the current scan line, respectively.

18. The method of claim 17, wherein the substantially constant voltage comprises a low level voltage relative to a first power supply voltage of the first power supply, the method further comprising raising the light emitting control signal to a high level voltage relative to the low level voltage after the current scan signal is supplied through the current scan line.

19. The method of claim 18, further comprising sequentially supplying the previous scan signal and then the current scan signal with a low level previous scan voltage relative to the first power supply voltage and a low level current scan voltage relative to the first power supply voltage, respectively.
